(19) United States
(12) Patent Application Publication
(10) Pub. No.: US 2005/0192876 A1
(43) Pub. Date: Sep. 1, 2005

(54) Software application for teaching cost accounting

(76) Inventor: A. James McKee JR., Johns Island, SC (US)

Correspondence Address: SARA A. CENTIONI;NEXSEN PRUET, LLC, POST OFFICE DRWR 2426, COLUMBIA, SC, 29202-2426, US

(21) Appl. No.: 11/069,454

(22) Filed: Mar. 1, 2005

Related U.S. Application Data
(60) Provisional application No. 60/549,007, filed on Mar. 1, 2004.

(51) Int. Cl. G06F 17/60

(52) U.S. Cl. 705/30

(57) ABSTRACT

A software application teaches cost accounting using a simplified cost system. The main screen of the software application is a schematic flowchart of inventory-related accounts and their supporting liability accounts. Each account is displayed in an X configuration. Each account is related to at least one other account on the schematic based on logical cost accounting relationships. The four nodes from the corners of each X-configured cluster are linked to screens that permit transaction data to be entered and transaction reports and ledgers to be displayed. The top left node of each cluster is always the balance in that account at the start of a month, the top right node is always the balance in that account at the end of a month, the bottom left node is the cost that is transferred into that account at the beginning of a month, and the bottom right node is the cost transferred out of that account at the end of the month.

### CROSS REFERENCE TO RELATED APPLICATIONS

Priority is claimed to U.S. provisional patent application Ser. No. 60/549,007, filed Mar. 1, 2004, which is incorporated herein by reference.

### BACKGROUND OF THE INVENTION

Generally, the present invention relates to computer software used in teaching. In particular, the present invention relates to an interactive computer software program directed toward teaching cost and management accounting for manufacturing-related transactions.

In learning new topics, many students fail to grasp the overriding concepts because they are overwhelmed by details. Particularly in the subject of accounting, students focus on the bookkeeping activities of debiting and crediting accounts, memorizing schedules and thinking in terms of journal entries instead of concentrating on the economic substance of the transactions. Unfortunately, because of this focus on the little picture rather than the big picture, students will likely forget what they have learned shortly after completing the class. When faced with cost accounting problems in the real world, these students will not be able accounting principles because what had been learned has subsequently been forgotten. They will be unable to retain what they had “learned” because they really never adequately understood the topics to begin with.

Although numerous teaching methods exist for accounting, all require a traditional focus, which includes students to complete journal entries and schedules. No known teaching method currently exists that allows students to understand accounting concepts without completing the journal entries.

Accounting education is in the midst of a dramatic transition from traditional (bookkeeping) focus to one emphasizing knowledge and skills related to accounting technology. Various critiques, such as the “Bedford Committee” (the American Accounting Association Committee, 1986), the Big Six “White Paper” (Perspectives on Education, 1989), and the Accounting Education Change Commission's Position Statement Number One (AECC, 1990), have urged a focus shift towards knowledge and skills related to information technology, computing, and systems. The AECC's Position Statement Number Two (1991, p. 250) asserts the first accounting course should address “ . . . the principles underlying the design, integrity, and effectiveness of accounting information systems”.

There is a trend to use technology in accounting instruction. Indeed, research has resulted in high expectations for computer-assisted teaching. Some researchers (Clark 1983 and Solomon 1994) believe that this direction has the potential to change the foundations of education. They have asserted that the use of such technology is in the third revolution in higher education in recent years after television and the microcomputer. With today's affordable and user-friendly development software, accounting educators can build their own accounting systems. If these display the same fundamental controls and functionality that have been embodied in traditional commercial accounting packages, students may learn them more quickly but the traditional approaches may need to be rethought, too

Therefore, there is a need for a tutorial that provides students with accounting training that not only provides an understanding of the principles of accounting but also connects those principles with journal entries.

The use of computer-assisted learning in all fields has increased dramatically in recent years. Computers facilitate the arrangement of information more creatively and effectively, especially through the Internet, and can allow an individual student to proceed at his or her own pace.

Computers also facilitate learning in other ways. They can combine graphic displays, perhaps video displays, in addition to text to make learning more interesting, perhaps even entertaining. Furthermore, they allow a level of interactivity that can be comparable, in some respects, to having one teacher dedicated to each student. Computers can, for example, test students and adapt to students learning needs as indicated by the results of those tests, questioning a student more in subject areas that a student needs more work on. See for example, U.S. Pat. No. 5,774,357 issued to Hoffburg et al Jun. 30, 1998.

No subject, it seems, is immune to teaching through use of a software application, including accounting. See for example, WO 0038155, A System, Method and Article of Manufacture for a Simulation Enabled Accounting Tutorial System. However, simply employing a computer to present the subject of cost accounting does not by itself make this subject easier to understand, notwithstanding the considerable advantages of computer technology in the learning process.

Thus there remains a need for better ways to teach cost accounting, preferably ways that can be employed using computer software.

### SUMMARY OF THE INVENTION

According to its major aspects and briefly recited, the present invention is a software application that teaches cost accounting using a simplified cost system. The main screen of the software application is a flowchart of inventory-related accounts and their supporting liability accounts. Each account is depicted as a cluster of nodes displayed in an X configuration. Each cluster is related to at least one other cluster on the flowchart based on logical cost accounting relationships. The four nodes from the corners of each X-configured cluster are linked to screens that permit transaction data to be entered. The top left node of each cluster is always the balance in that account at the start of a month, the top right node is always the balance in that account at the end of a month, the bottom left node is the cost that is transferred into that account at the beginning of a month, and the bottom right node is the cost transferred out of that account at the end of the month.

The sum of the amounts in the top left and bottom left entries should equal the sum of the amounts in the top right and bottom right entries, because the sum of what was in that account at the start of the month plus what was added to that account must equal what was left over in that account at the end of the month plus what was transferred out of it. Thus, the numbers displayed on the main screen's schematic are really the macro-level cost flows of the cost system presented. As the student progresses through the various transactions and events (e.g. internal transfers of inventory from stockroom to production to warehouse), the result of each transaction and event and their impact on other transactions and events is displayed on the various clusters in the schematic.

The present computer software application allows those studying cost accounting to input data, prompted by the software application, to create their own accounting problems, and to proceed through to the solutions of those problems while observing the development of the cost accounting solution as they do.

Use of a single application page or screen to show a complete summary of the cost accounting information, including transaction files and master files, is an important feature of the present invention and, at the macro level, makes the cost accounting transparent. This summary page not only continuously updates as data is input but dynamically links data across the clusters so that the user can see which transactions are logically connected. For example, the amount transferred out of the “work in process” unit also appears as the amount transferred into the “finished goods” unit.

The use of computer technology to present this new approach to teaching cost accounting is another feature of the present invention. Computer technology, and particularly object-based programming, gives the developer of a tutorial much more flexibility than textbooks and blackboards provide in the use of graphics and multi-dimensional information architecture. Thus the concepts and information being conveyed can be organized in new and helpful ways rather than linearly as in textbooks. Furthermore, tutorial software applications can be distributed or accessed over networks, making it easier and less expensive to provide the tutorial.

The present tutorial shifts focus towards knowledge and skills related to information technology, computing, and systems. In the present invention, the schematic is applied to a job-order cost system. Then, the cost flow schematic is transformed into an electronic cost engine. Specifically, various, schematic transaction nodes are made into data access points for raw data entry. Other basic features commonly associated with computer-based accounting packages are added as well. Each PC screen is designed to depict a specific type of event, e.g. receiving raw material, processing time tickets, transfers to warehouse.

Another feature of the present invention is the use of cartoons, not merely to entertain the student, but to connect the cost accounting concept with a real world image, albeit in cartoon form. As soon as the southwest node of the raw material cluster has been selected, for example, the user will see a cartoon of a forklift operator unloading raw material from a truck at the receiving dock. This use of cartoons not only connects the dry transaction with a real world image of what is actually taking place in a company, but subtly provides a mnemonic for the student for that transaction.

The industrial utility of the present invention is two-fold. First, the present software application can be used to instruct those who wish to become familiar with cost accounting in its principles. Second, it can be used to solve real problems of cost accounting. In this last regard, it will be clear that the present invention can be adapted in a straightforward way to a cost-accounting software application for use in manufacturing businesses merely by providing it with sufficient flexibility for receiving input from various sources such as time ticket transactions, vendor information and so on, and by giving it sufficient memory to carry data forward from one accounting interval to the next.

Other features and their advantages will be apparent to those skilled in the art of teaching cost accounting from a careful reading of a Detailed Description Of Preferred Embodiments accompanied by the following drawings.

### BRIEF DESCRIPTION OF THE SEVERAL VIEWS OF THE DRAWINGS

FIG. 1 is a screen shot showing a schematic flow chart that depicts cost accounting in overview, according to a preferred embodiment of the present invention;

FIG. 2 is a screen shot showing a cartoon for the receipt of raw materials, according to a preferred embodiment of the present invention;

FIG. 3 is a screen shot showing input of raw materials being purchased, according to a preferred embodiment of the present invention;

FIG. 4 is a screen shot showing a list of raw material purchase transactions, according to a preferred embodiment of the present invention;

FIG. 5 is a screen shot showing the journal entry of raw materials purchased, according to a preferred embodiment of the present invention;

FIG. 6 is a screen shot showing the schematic of FIG. 1 with the impact of the purchase of raw materials of FIG. 3, according to a preferred embodiment of the present invention;

FIG. 7 is a screen shot showing a cartoon illustrating the requisitioning of raw materials, according to a preferred embodiment of the present invention;

FIG. 8 is a screen shot showing the selection of costing method for material in inventory, according to a preferred embodiment of the present invention;

FIG. 9 is a screen shot showing the selection of input for raw materials being requisitioned, according to a preferred embodiment of the present invention;

FIG. 10 is a screen shot showing a list of stockroom transactions of requisitioned materials for Job A, according to a preferred embodiment of the present invention;

FIG. 11 is a screen shot showing the journal entries for raw materials requisitioned for Job A, according to a preferred embodiment of the present invention;

FIG. 12 is a screen shot showing the schematic of FIG. 1 showing the impact of the requisitioned raw materials as shown in FIG. 10, according to a preferred embodiment of the present invention;

FIG. 13 is a screen shot showing the raw material ledger now reflecting the receipt and requisitioning of raw materials, according to a preferred embodiment of the present invention;

FIG. 14 is a screen shot showing a cartoon illustrating the manufacturing workers as a symbol of wages payable, according to a preferred embodiment of the present invention;

FIG. 15 is a screen shot showing input to a time ticket for a first worker who worked on job A, according to a preferred embodiment of the present invention;

FIG. 16 is a screen shot showing a list of time ticket transactions processed for all workers who worked on Job A, according to a preferred embodiment of the present invention;

FIG. 17 is a screen shot showing the journal entries for the time tickets processed for a worker who worked on Job A, according to a preferred embodiment of the present invention;

FIG. 18 is a screen shot showing the schematic of FIG. 1 with the effect of the processing of the first time ticket, according to a preferred embodiment of the present invention;

FIG. 19 is a screen shot showing the wages payable ledger following processing of the first time ticket, according to a preferred embodiment of the present invention;

FIG. 20 is a screen shot showing a cartoon for the incurred manufacturing overhead, according to a preferred embodiment of the present invention;

FIG. 21 is a screen shot showing selection of a type of manufacturing overhead costs, according to a preferred embodiment of the present invention;

FIG. 22 is a screen shot showing the cost input for the type of manufacturing overhead cost selected in FIG. 21, according to a preferred embodiment of the present invention;

FIG. 23 is a screen shot showing a list of manufacturing overhead cost transactions, according to a preferred embodiment of the present invention;

FIG. 24 is a screen shot showing the journal entries for another type of manufacturing cost incurred, according to a preferred embodiment of the present invention;

FIG. 25 is a screen shot showing the schematic of FIG. 1 with impact of the manufacturing cost overhead input, according to a preferred embodiment of the present invention;

FIG. 26 is a screen shot showing the manufacturing overhead expense ledger, according to a preferred embodiment of the present invention;

FIG. 27 is a screen shot showing input for manufacturing overhead costs as applied, according to a preferred embodiment of the present invention;

FIG. 28 is a screen shot showing a list of manufacturing overhead expense transactions applied, according to a preferred embodiment of the present invention;

FIG. 29 is a screen shot showing the journal entries for applied manufacturing overhead expenses, according to a preferred embodiment of the present invention;

FIG. 30 is a screen shot showing the schematic of FIG. 1 with the impact of the applied manufacturing overhead expenses, according to a preferred embodiment of the present invention;

FIG. 31 is a screen shot showing the manufacturing overhead applied account ledger, according to a preferred embodiment of the present invention;

FIG. 32 is a screen shot showing a cartoon illustrating the delivery to finished goods from work in process, according to a preferred embodiment of the present invention;

FIG. 33 is a screen shot showing the input to the transfer of finished goods for Job A, according to a preferred embodiment of the present invention;

FIG. 34 is a screen shot showing a list of all transfers to finished goods, according to a preferred embodiment of the present invention;

FIG. 35 is a screen shot showing the journal entries for transfers of finished goods, according to a preferred embodiment of the present invention;

FIG. 36 is a screen shot showing the schematic of FIG. 1 with the impact of the transfers of finished goods, according to a preferred embodiment of the present invention;

FIG. 37 is a screen shot showing the work in process ledger, according to a preferred embodiment of the present invention;

FIG. 38 is a screen shot showing a cartoon illustrating delivery of finished goods, according to a preferred embodiment of the present invention;

FIG. 39 is a screen shot showing the input for the shipping bill of lading, according to a preferred embodiment of the present invention;

FIG. 40 is a screen shot showing a list of all bills of lading, according to a preferred embodiment of the present invention;

FIG. 41 is a screen shot showing the journal entries for the bill of lading, according to a preferred embodiment of the present invention;

FIG. 42 is a screen shot showing the schematic of FIG. 1 with the impact of the shipped goods, according to a preferred embodiment of the present invention;

FIG. 43 is a screen shot showing the finished goods ledger, according to a preferred embodiment of the present invention;

FIG. 44 is a screen shot showing the input to a customer billing transaction to create a sales receipt, according to a preferred embodiment of the present invention;

FIG. 45 is a screen shot showing a list of sales billing transactions, according to a preferred embodiment of the present invention;

FIG. 46 is a screen shot showing the journal entries for the billing transaction, according to a preferred embodiment of the present invention;

FIG. 47 is a screen shot showing the schematic of FIG. 1 with the impact of the billing transaction, according to a preferred embodiment of the present invention;

FIG. 48 is a screen shot showing the sales ledger, according to a preferred embodiment of the present invention;

FIG. 49 is a screen shot showing the input to the operating expenses, according to a preferred embodiment of the present invention;

FIG. 50 is a screen shot showing a list of operating expenses, according to a preferred embodiment of the present invention;

FIG. 51 is a screen shot showing the journal entries for the operating expense, according to a preferred embodiment of the present invention;

FIG. 52 is a screen shot showing the schematic of FIG. 1 with the impact of operating expenses, according to a preferred embodiment of the present invention;

FIG. 53 is a screen shot showing the operating expenses ledger, according to a preferred embodiment of the present invention;

FIG. 54 is a screen shot showing input corresponding to customer payments, according to a preferred embodiment of the present invention;

FIG. 55 is a screen shot showing a list of cash received as a result of customer payments, according to a preferred embodiment of the present invention;

FIG. 56 is a screen shot showing the journal entries for customer payments, according to a preferred embodiment of the present invention;

FIG. 57 is a screen shot showing the schematic of FIG. 1 with the impact of customer payments included, according to a preferred embodiment of the present invention;

FIG. 58 is a screen shot showing input corresponding to payments to vendors, according to a preferred embodiment of the present invention;

FIG. 59 is a screen shot showing a list of payments to vendors, according to a preferred embodiment of the present invention;

FIG. 60 is a screen shot showing journal entries for a vendor payment, according to a preferred embodiment of the present invention;

FIG. 61 is a screen shot showing the schematic of FIG. 1 with the impact of payments to vendors included, according to a preferred embodiment of the present invention;

FIG. 62 is a screen shot showing the cash ledger including both payments from customers and to vendors, according to a preferred embodiment of the present invention;

FIG. 63 is a screen shot showing the trial balance, income statement and owner's equity, according to a preferred embodiment of the present invention; and

FIG. 64 is a screen shot showing the trial balance, owner's equity, and balance sheet, according to a preferred embodiment of the present invention.

### DETAILED DESCRIPTION OF THE INVENTION

The present invention is a software application that teaches cost accounting. The software application is designed to run on a general-purpose computer and can be used by programming that computer with a compact disk or by accessing the software via a computer network. In particular, this software application can be accessed via the internet and either a copy can be downloaded to the local computer or a master copy can maintained on a remote server for access by authorized students.

The present invention employs conventional graphical user interface techniques for enabling computer users to obtain information, enter data and make choices using a computer user interface. It employs object-based programming techniques in a windows-type operating system, well known to software programmers. The software objects have the appearance of virtual buttons, pull-down menus, dialog boxes, and other features well known for use in navigating a software application and for entering text and data. Each object will have properties and methods established by the programmer so that the object will operate as programmed.

To interact with the software, the computer user interface may include a mouse, track ball or touch pad to move a curser over a software object that appears on a computer monitor and then activate the software object by clicking the left button of the mouse when the curser is in place over the object to cause a window to appears where the object had been. The window may contain detailed information, a list of choices, or other objects that when “clicked,” provides choices or returns the user to the original window closing the window just opened.

The present invention is a particular approach to cost accounting presented using specific combinations of these software programming techniques and not the techniques alone.

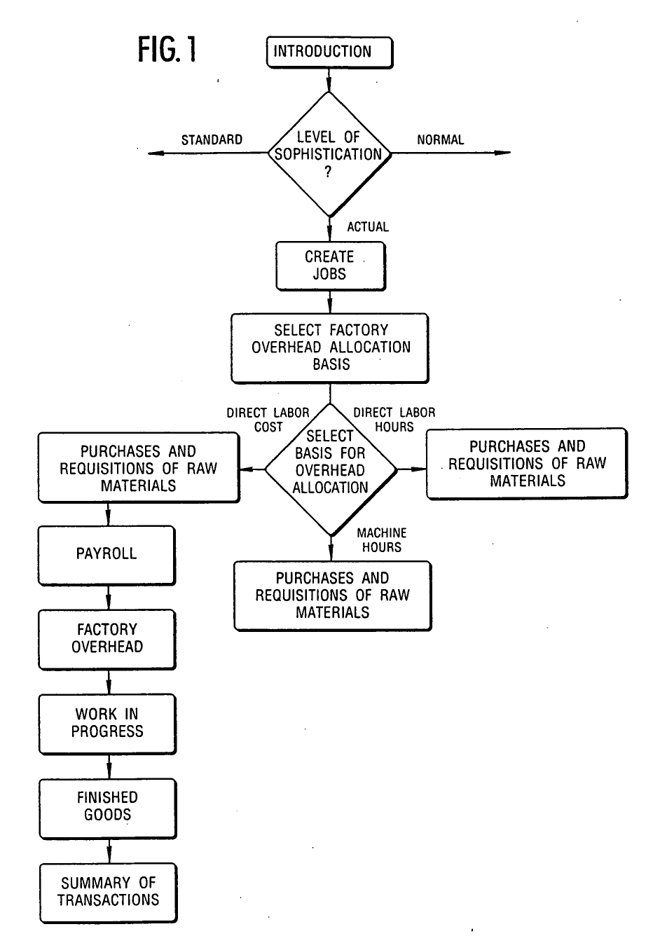

The main screen of the present cost accounting software application, as illustrated in FIG. 1, is a schematic diagram. This schematic diagram is central to the cost system, and represents the macro-level display of all cost flows through the cost system. The schematic diagram shown in FIG. 1 is a systems flowchart comprised of inventory-related accounts and supporting liability accounts, each of which is displayed as a cluster of nodes in an X configuration. Each cluster is logically linked to one or more other clusters in the schematic. The nodes, which are the corners of each X-configured cluster, are linked to transaction entry windows. As the student progresses through the various types of transactions and events (e.g. internal transfers of inventory from stockroom to production to warehouse), he will view the display of each as it impacts the schematic.

There are seven major accounts that are the principal components of a schematic cost flow network as seen in FIG. 1. Five of them are inventory-related (raw material, work-in-process, finished goods, manufacturing overhead expense, and manufacturing overhead applied) and two are liabilities (wages payable and vendors payable). Additionally, there are two other components that play more minor role but are included (accounts payable and cash). Each account component except for manufacturing overhead is displayed using the X configuration. The top two nodes, designated as the northwest or NW node and the northeast or NE nodes for convenience, denote beginning and ending balances, respectively, and the bottom two nodes, designated as the southwest or SW and southeast or SE nodes, denote incoming and outgoing costs. The four nodes of the X configuration thus comprise an account cluster. The sum of the amounts in the NE and SE nodes logically must equal the sum of the amounts in the NW and SW nodes, and the schematic diagram of FIG. 1 provides for this sum to be displayed for each X configuration and uses the computer's computational capabilities to determine each sum.

Whenever a transaction is entered in one node of one cluster, the corresponding dollar amounts in the transaction files and corresponding master files of other clusters are automatically updated. Therefore, a user who enters data regarding one transaction will see the effect of that transaction in other account clusters as well.

The present system has two layers of display. The top layer is the summary schematic, as seen in FIG. 1; the supporting layer consists of master files, transaction files, job order cost sheets, and so forth that is similar to traditional cost accounting systems.

Referring now specifically to the schematic in FIG. 1, basic input for an example of a cost accounting problem can be provided by an instructor, or selected from a set of built-in default problems, or created by the student. The student will then enter data or select the default input and proceed to compute (using the software's internal computational capability) all of the values of each node of each cluster for that problem. As the input is entered and calculations performed, the solution unfolds and, moreover, the relationship among the various accounts becomes clear.

There are eleven different types of transactions that comprise the present cost system. These include the following:

| | | |
|---|---|---|
| 1. | Receiving raw material | Raw Material (SW node) |
| 2. | Stockroom requisitions | Raw Material (SE node) |
| 3. | Manufacturing labor | Wages Payable (SW node) |
| 4. | Manufacturing overhead costs | Moh Tank (C) |
| 5. | Manufacturing overhead applied | Moh Tank (A) |
| 6. | Transfers to finished goods | Finished Goods (SW node) |
| 7. | Shipments to customers | Finished Goods (SE node) |
| 8. | Billings to customers | Profit & Loss (Sales) |
| 9. | Operating expenses | Profit & Loss (Operating expense) |
| 10. | Customer remittances | Cash (SW node) |
| 11. | Cash payments | Cash (SE node). |

The various values associated with each component are initially set to zero. As the solution develops, values are entered into each of the eleven transaction boxes so that, ultimately, all of the values can be either entered or calculated, and the complete flow of costs can be seen.

Each component has a heading in a title bar containing the name of that component. These headings include “Raw Materials”, “Work in Process”, “Finished Goods”, “Wages Payable”, “Profit/Loss”, “Vendors Payable”, “Accounts Payable”, and “Cash”. These title bars are also virtual button that can be “clicked” to reveal master files in the underlying layer. The corners of the clusters are also small virtual buttons that can be clicked to enter data in the node next to that corner.

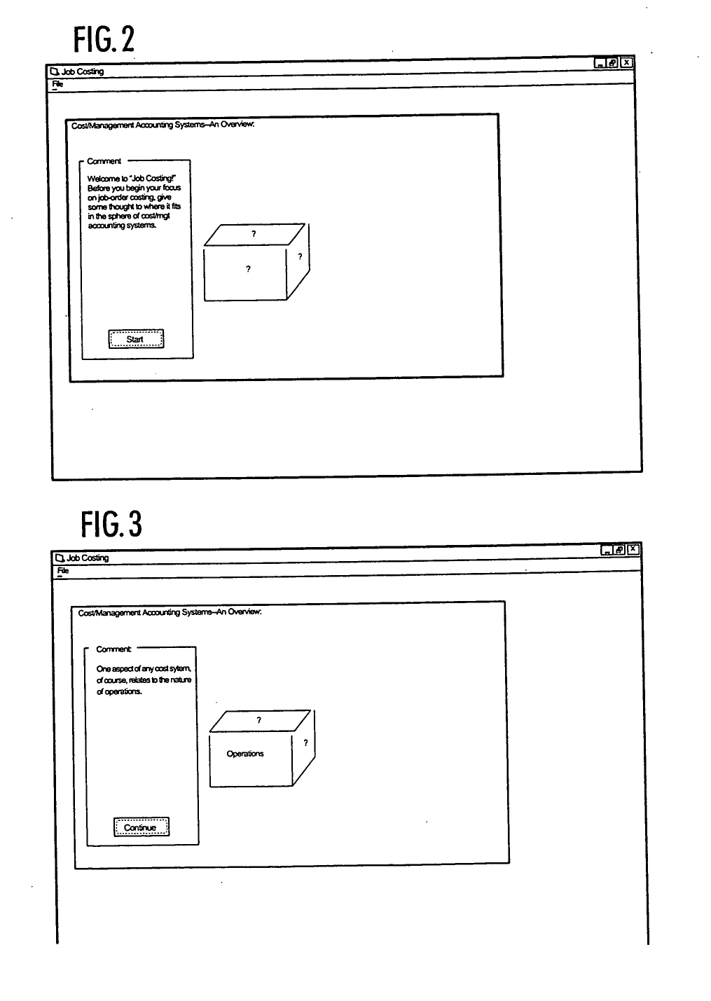

Clicking on the southwest corner of the Raw Materials component X produces a cartoon, shown in FIG. 2, of a delivery to the receiving department of a manufacturer. Although this cartoon (or any other cartoon or image illustrating a delivery of raw materials, is optional, it does help to connect the account with what would be happening in a manufacturing facility and places the information to be added to this account in context.

The user then clicks on the “click here” button to shift from the cartoon to a window showing the “receiving” department of FIG. 3. The user can now enter the names of a vendors or select vendors from a set of default names in a drop down menu (or change the default names), enter or select a type of material from each vendor, enter the quantities purchased, and enter the unit costs of the materials purchased. The total cost for that quantity at that unit cost is then calculated automatically upon clicking on the “process entry” button.

The user also has the option to “cancel” or “reset” the entries. The “cancel” button leaves this level and returns to the schematic diagram of FIG. 1; the “reset” button restores all values entered to what they were before, typically to zeros.

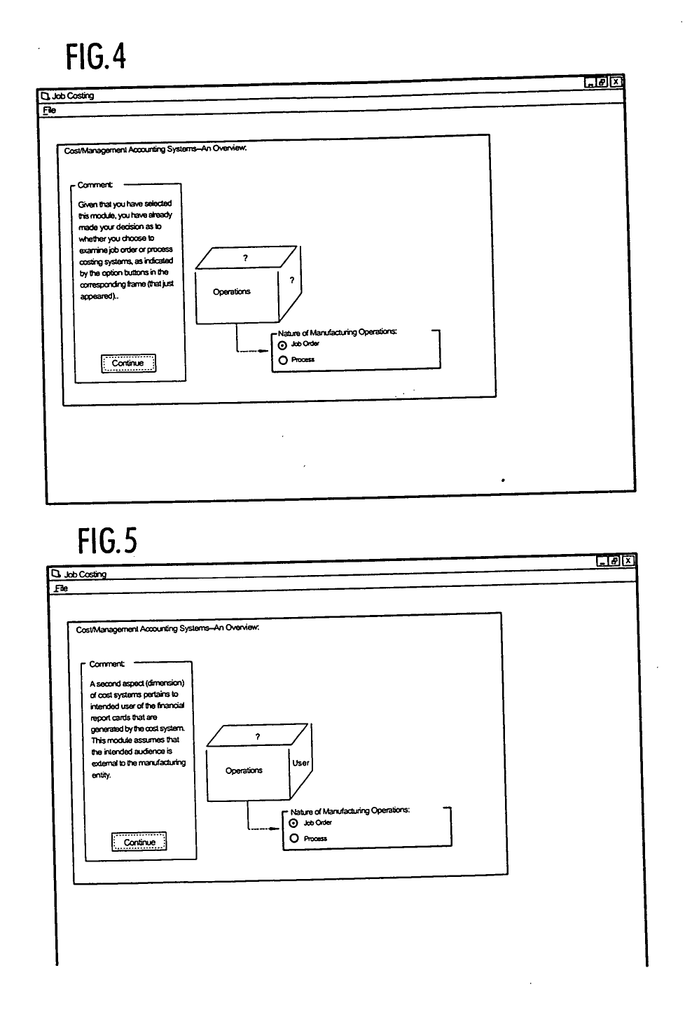

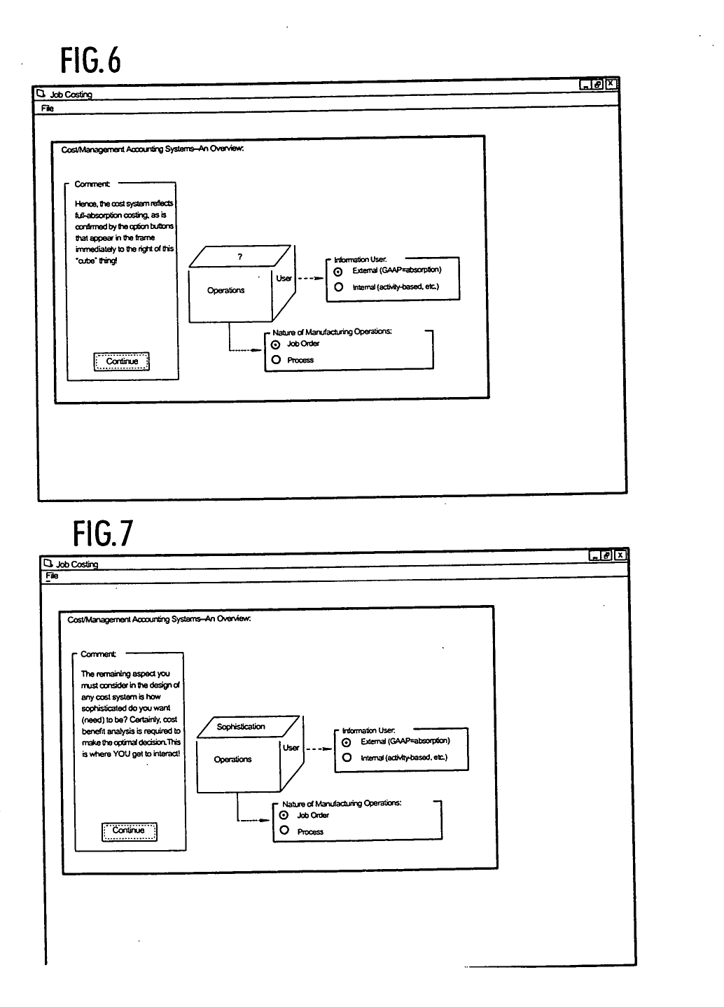

By clicking on the virtual “show all” button, the user can look at a list (FIG. 4) all of the raw material transactions entered during the prescribed interval. The user can see how journal entries of the master files should appear with the data just entered merely by “clicking” on the “show journal entry” virtual button (FIG. 5). The journal entry will list that raw material at the correct dollar amount and show that a corresponding vendor payable amount has been created. By returning to the schematic of FIG. 1 as now shown in FIG. 6 using the “end session” button, the user will see the impact of the input of raw materials purchased in the SW and NE nodes of both the “raw materials” in the “vendors payable” component.

The user then proceeds to enter data for the remaining ten transactions identified above. As the user proceeds, other values will be determined by calculation or by transfer of entries from one cluster to another, with the solution unfolding in a logical progression across the main page. The details of the cost flow will be available by clicking on the title bars to access the general ledger.

The next transaction, item 2 in the list above, is to requisition raw materials. These are entered by clicking on the SE node of the raw materials cluster which produces another cartoon, as seen in FIG. 7, of raw materials leaving the stock room. Again, cartoons are optional but give a visual mnemonic to the transaction that the user will likely remember. By clicking on the “disable animation” button, the user disables the otherwise automatic appearance of the animated cartoon.

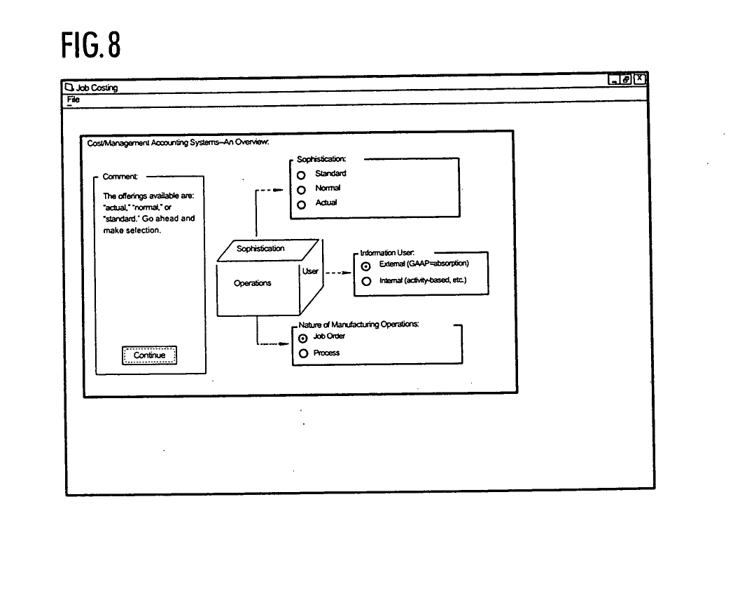

The SE corner of the raw materials component allows the user to identify the type and amount of raw materials that will be requisitioned during the accounting interval. Note that, following the raw materials requisition cartoon, the software application, in FIG. 8, prompts the choice of cost accounting method from between three choices: first in/first out (FIFO), last in/first out (LIFO) and use of a weighted average. Then the user clicks on a choice of accounting method and clicks on the process entry button to process that choice.

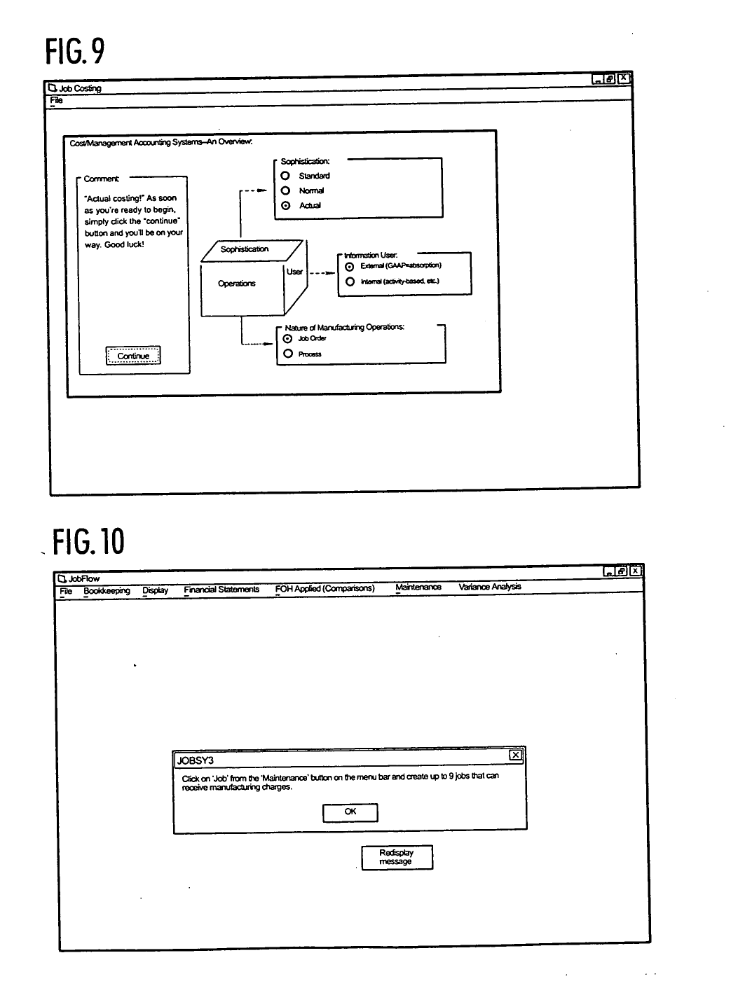

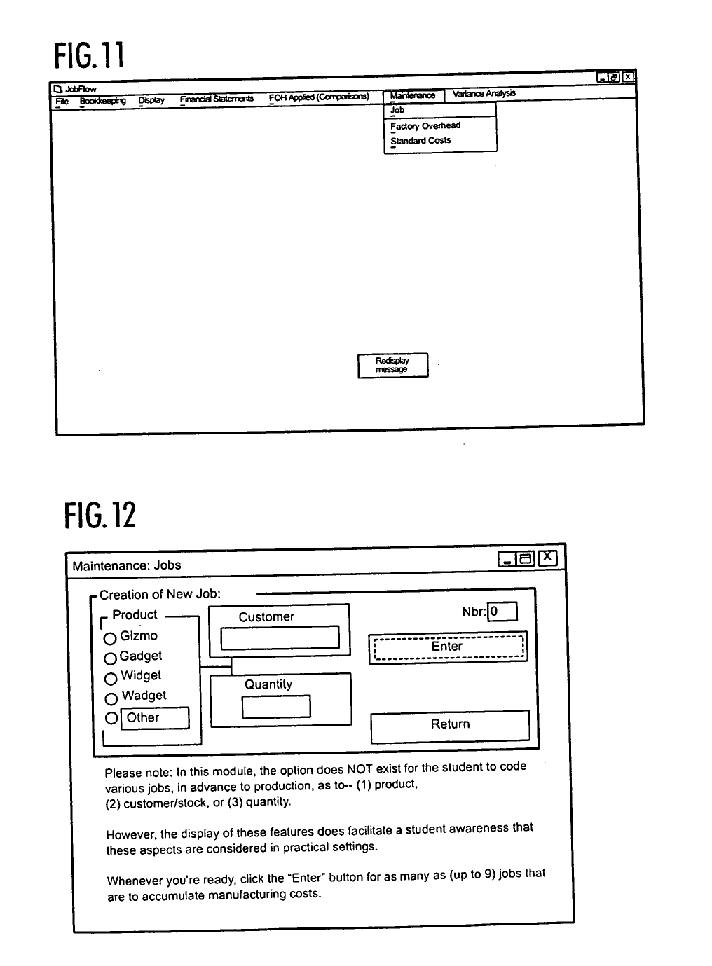

In FIG. 9, the user enters input reflecting the raw materials being requisitioned. As before, “show all” button lists all of the raw materials requisitioned, as seen in FIG. 10 and, as seen in FIG. 11, the journal entry for materials requisitioned is illustrated by clicking on the “journal entry” button. The user clicks on the “end session” button to return to the schematic flowchart of FIG. 1, now seen in FIG. 12 with the effect of the materials requisitioned now evident. The value of the raw materials requisitioned appears in the SE node of the “raw materials” cluster and the SW node of the “work in process” cluster and allows the calculation of the NE nodes of the “raw materials” and the “work in process” clusters. Note that the total of the NW and SW nodes of any cluster must equal the total of the NE and SE nodes.

For example, the amount requisitioned from the stock room (two units in the present example) may be less than the total amount received (five units) during the month plus the amount that was there initially, so the difference that must be there at the close of the month is automatically entered in the NE node adjacent to the X so that the sum of the NE node and SE node remain equal to the sums of the NW and SW nodes.

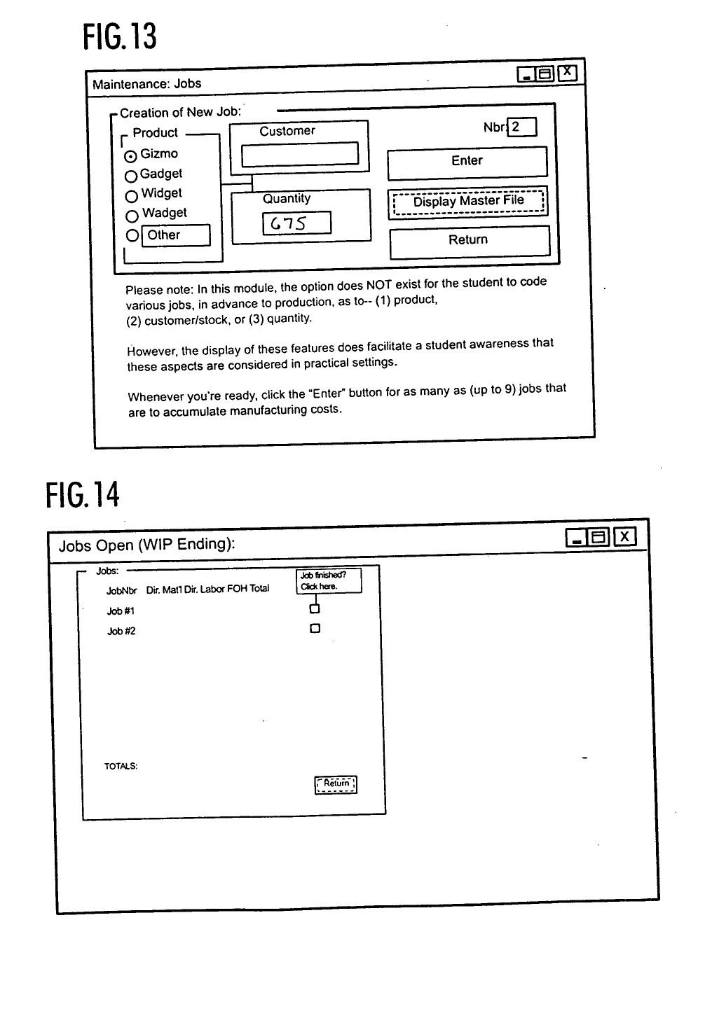

FIG. 13 is a screen shot showing the raw material ledger now reflecting the receipt and requisitioning of raw materials as selected by the user. Each user may input quantities, vendors, and types of materials to vary the example and to get a sense of the impact of such choices on the final cost accounting solution as it develops.

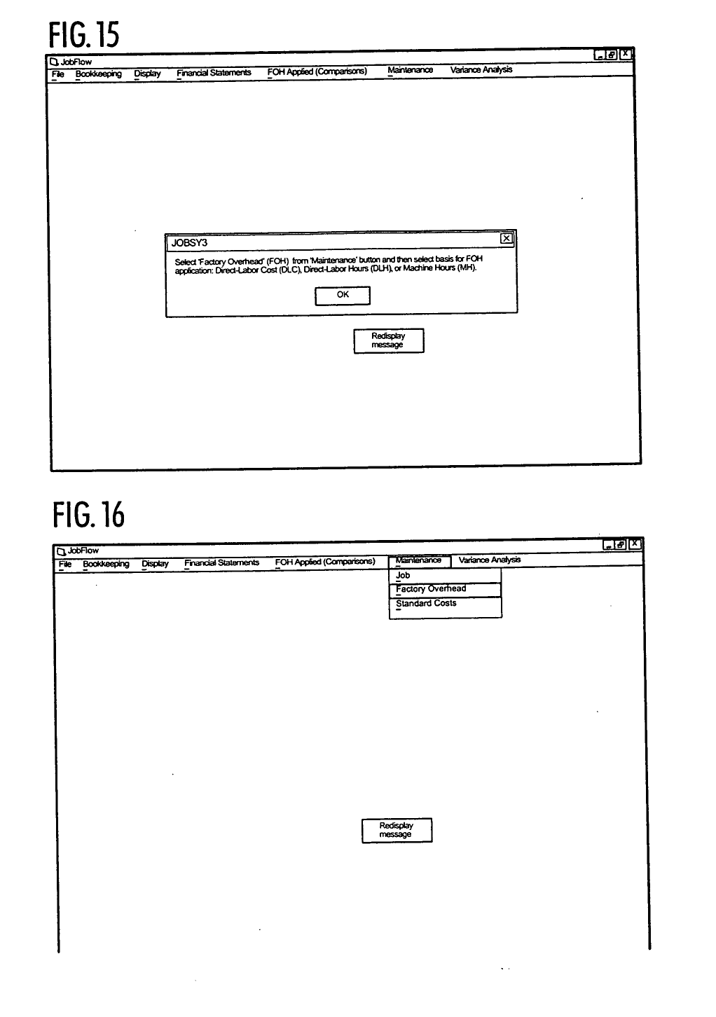

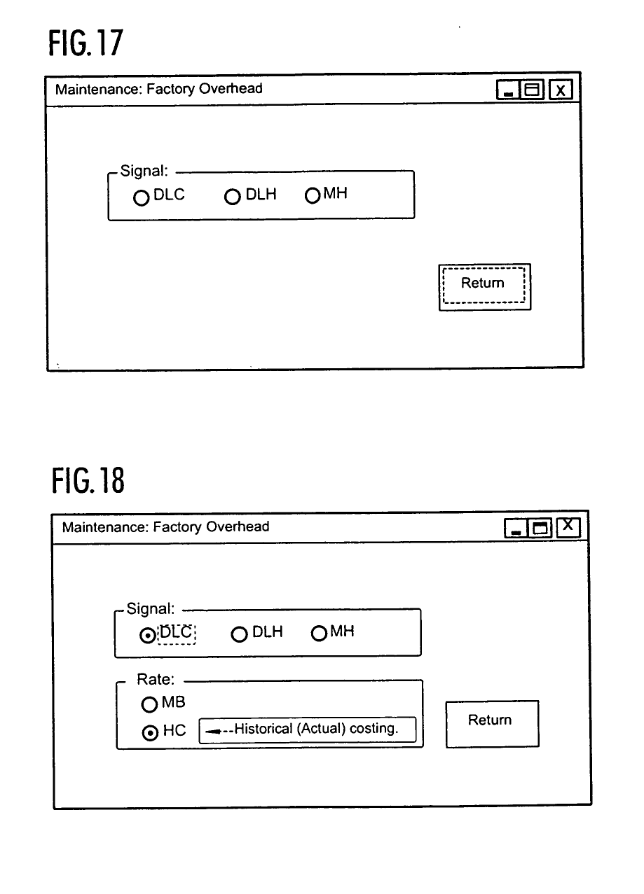

FIG. 14 is shows another cartoon illustrating the manufacturing workers as a symbol of wages payable. FIG. 15 is shows input to a time ticket, Time Ticket 1 or TT1, for a first worker (with the default name Moe) who worked two hours on job A and has a rate of “8”, according to this example. Just as with materials received and requisitioned, the user may see if list showing all of the time ticket transactions (see FIG. 16) and the journal entries for the time ticket transactions (see FIG. 17).

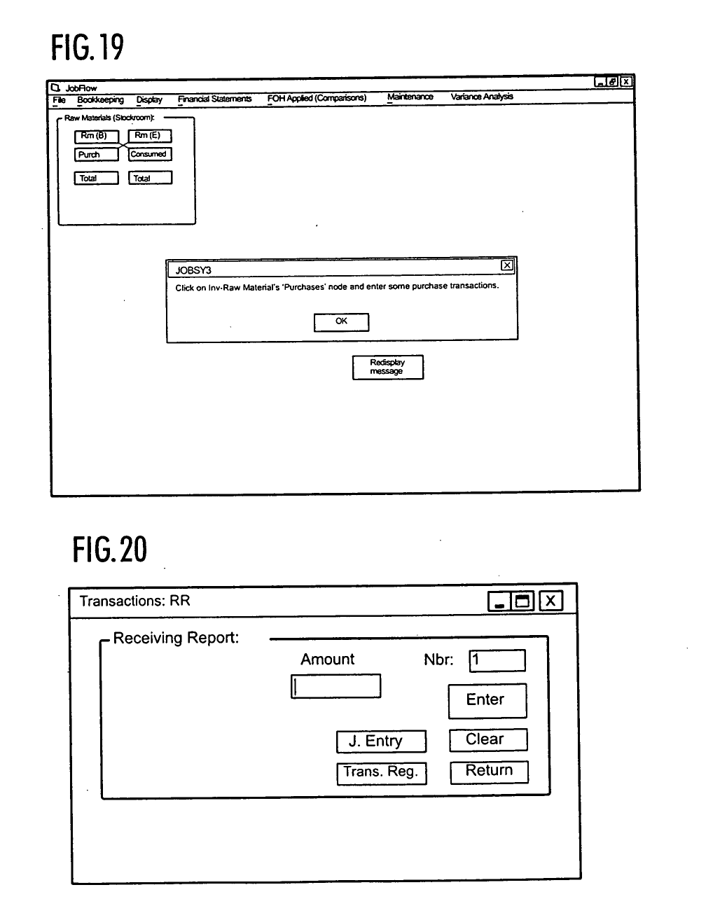

The user then ends the session in which time for each worker on each job was entered and returns to the schematic flowchart, now illustrated in FIG. 18 with the effect of the processing of the time tickets. In the example illustrated, only three time tickets were entered, for three different workers who all worked on Job A. The value of this labor is automatically entered into the SW and NE nodes of the “wages payable” cluster. Note that this value and the value of direct materials costs from the SW note of the “raw materials” cluster are also listed in the overhead box in the center of the schematic. The wages payable costs incurred for Job A are also entered automatically in the calculation of manufacturing overhead applied using a factor of 0.60 in this example. The wages payable ledger, illustrated in FIG. 19, shows these three time tickets.

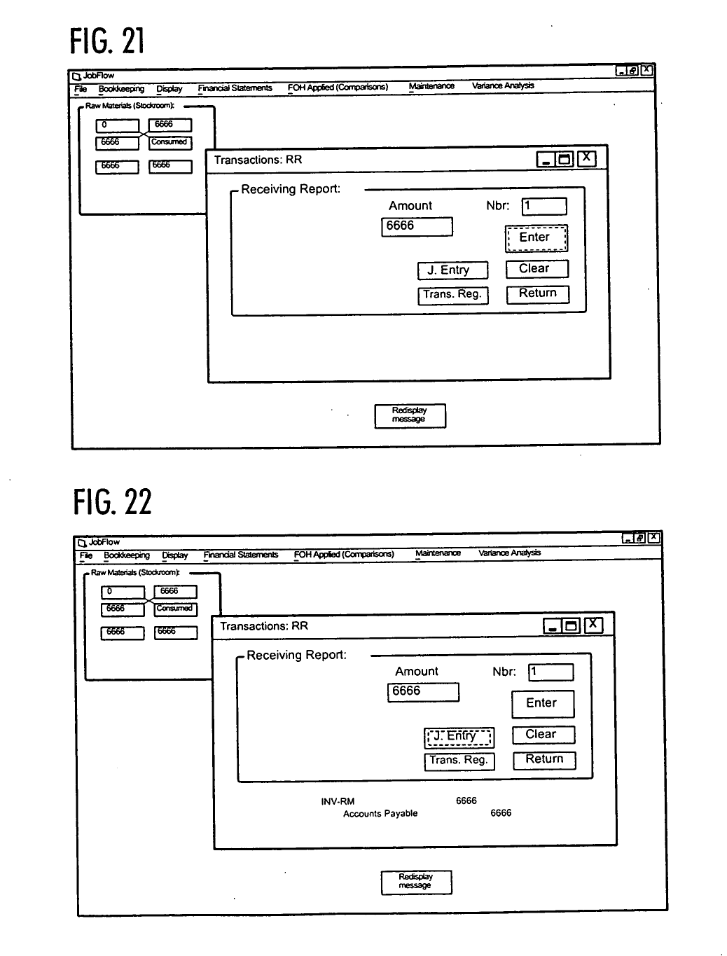

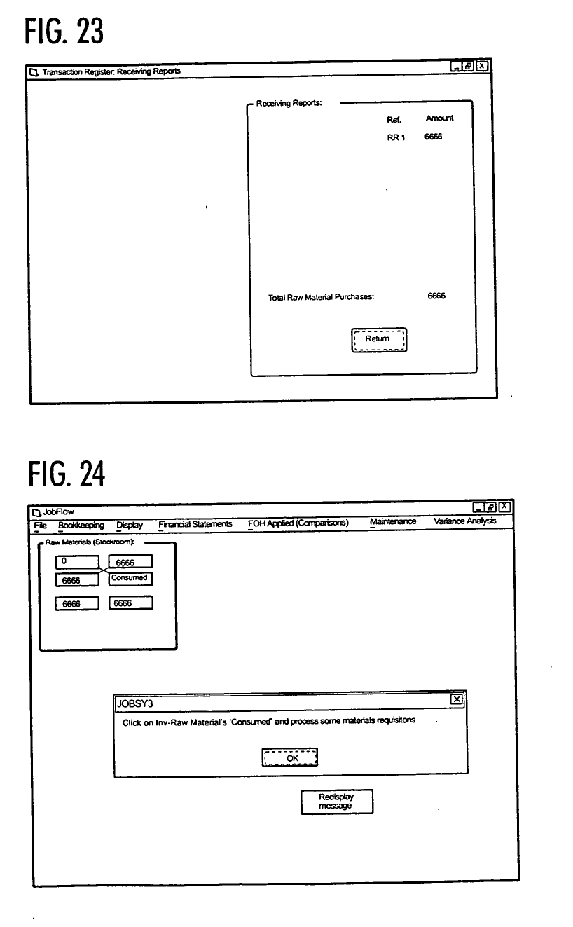

Moving on to overhead, FIG. 20 is shows a cartoon of a clerk processing bills received by the manufacturing company for the incurred manufacturing overhead expenses. This cartoon may also used for manufacturing overhead and applied overhead, and for sales, cost of good sold, operating profit and cash. There are several of these, listed in a pull down menu shown in FIG. 21, such as indirect labor, indirect material, utilities, taxes, insurance, and depreciation. In the example given, input for utilities and taxes are provided. See FIG. 22 for the utilities entry. Clicking on the “show all” button leads to the list of manufacturing overhead expenses incurred of FIG. 23. Clicking on the “journal entry” button shows, in FIG. 24, the example journal entry one of the expenses input.

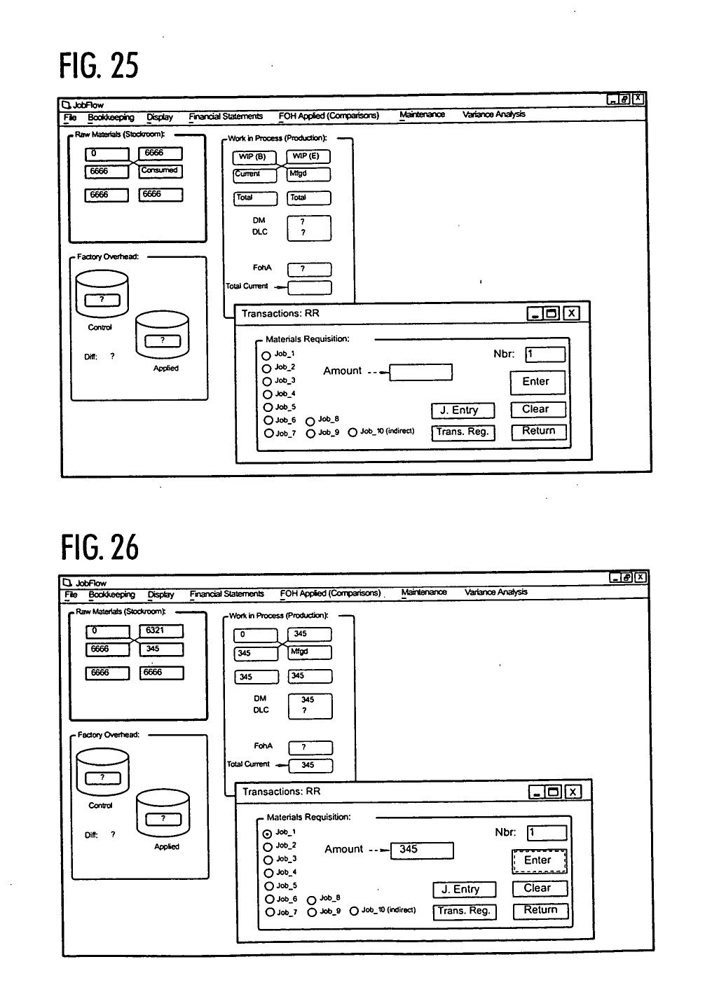

The user then clicks on the “end session” button to return to the schematic flow chart, shown in FIG. 25. The schematic shows the incurred overhead expenses in the overhead box and as accounts payable in the “accounts payable” cluster. Similarly, the manufacturing overhead costs are entered in the appropriate ledger, as shown in FIG. 26.

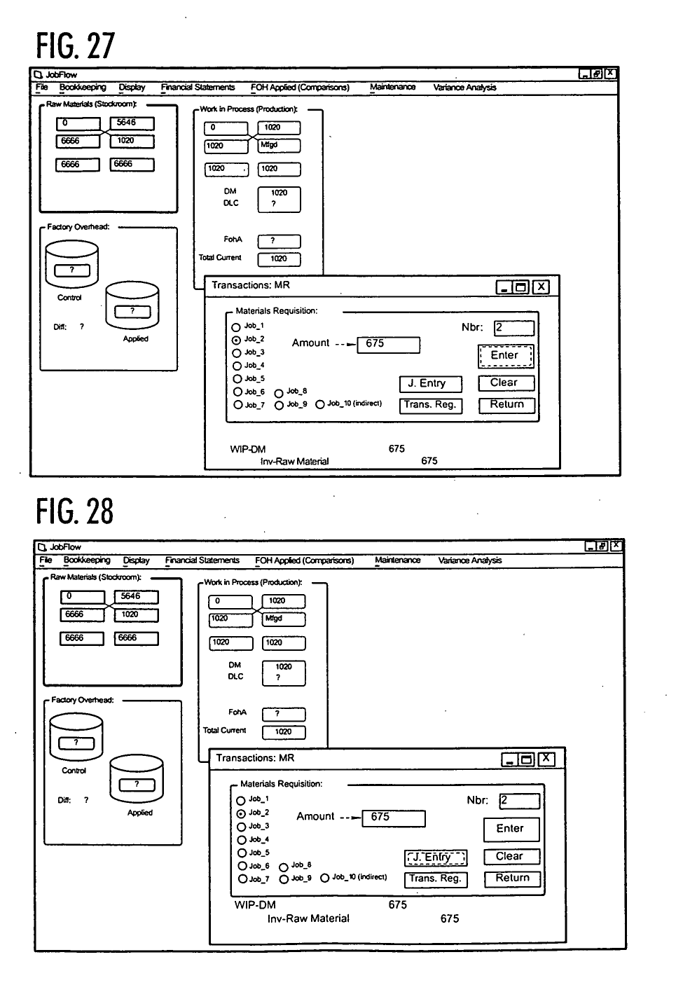

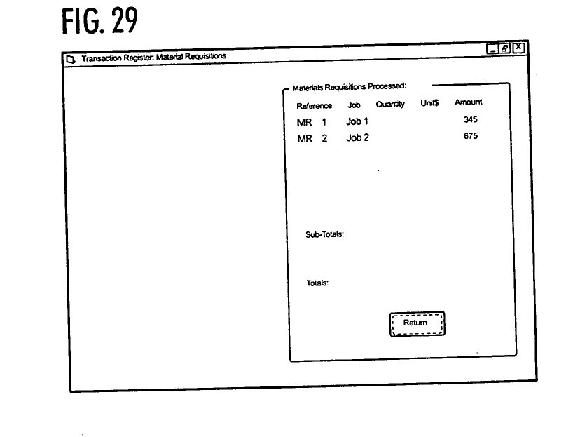

FIG. 27 is a screen shot showing input for manufacturing overhead costs as applied to Job A in which the value of 87 for the unprocessed direct labor (DL) cost is multiplied by the manufacturing overhead rate of 0.6 to yield an applied value of 52.2 applied to Job A, as listed in the transaction report shown in FIG. 28, and in the journal entries shown in FIG. 29.

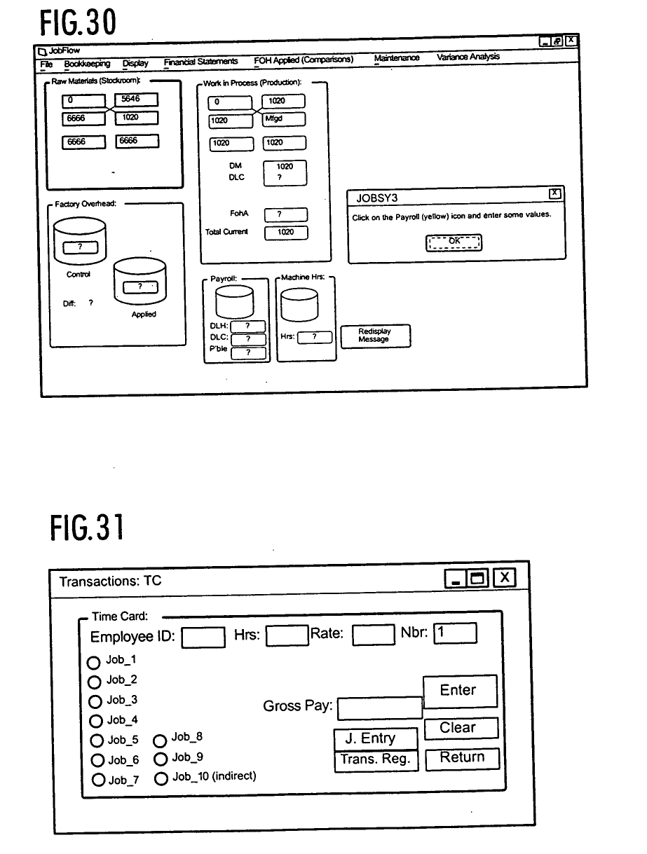

The user, upon returning to the schematic, shown in FIG. 30, will see the applied value of 52.2, leaving 297.8 unapplied. The applied overhead and direct material and direct labor costs results in a current cost of goods for Job A of 151.2, which is entered in the SW node of the “work in process” cluster. The ledger entry is shown in FIG. 31.

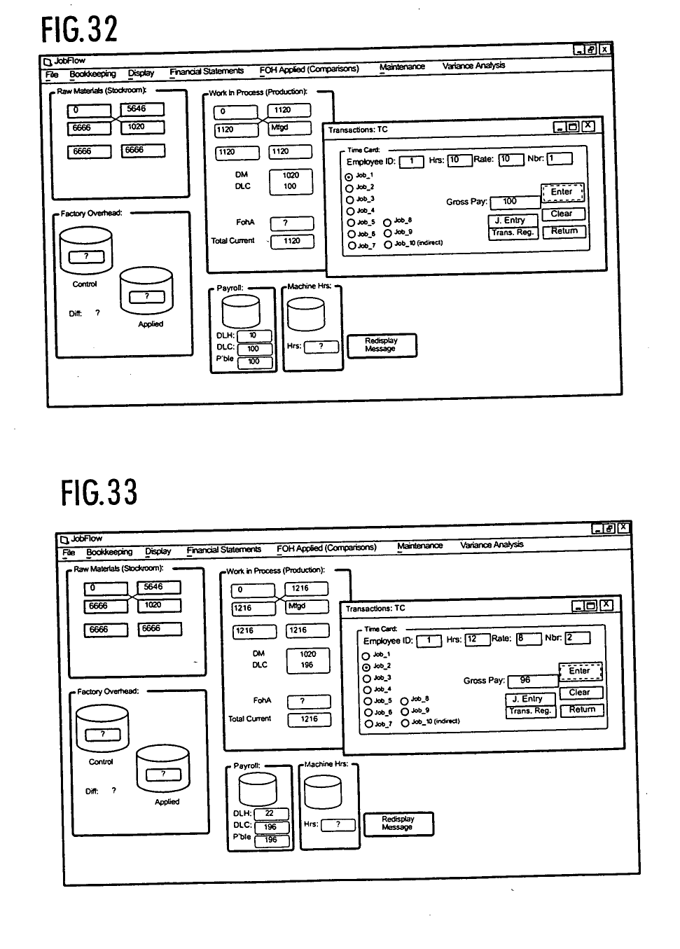

FIG. 32 is a screen shot showing a cartoon illustrating work in process. As stated above, all the animated cartoons are optional and can be disabled, but are useful in connecting the development of each step of the cost accounting solution to the events taking place at each step.

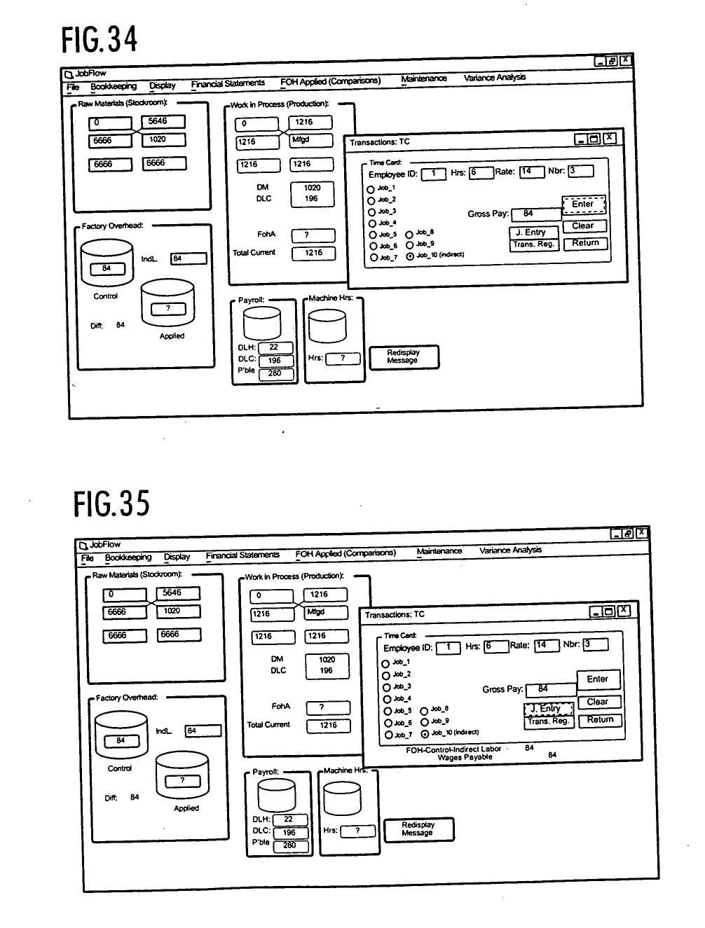

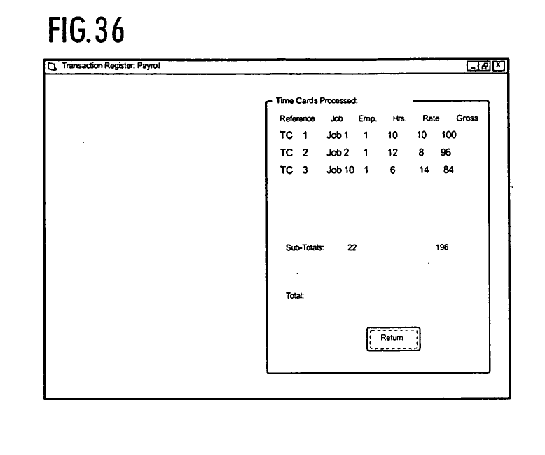

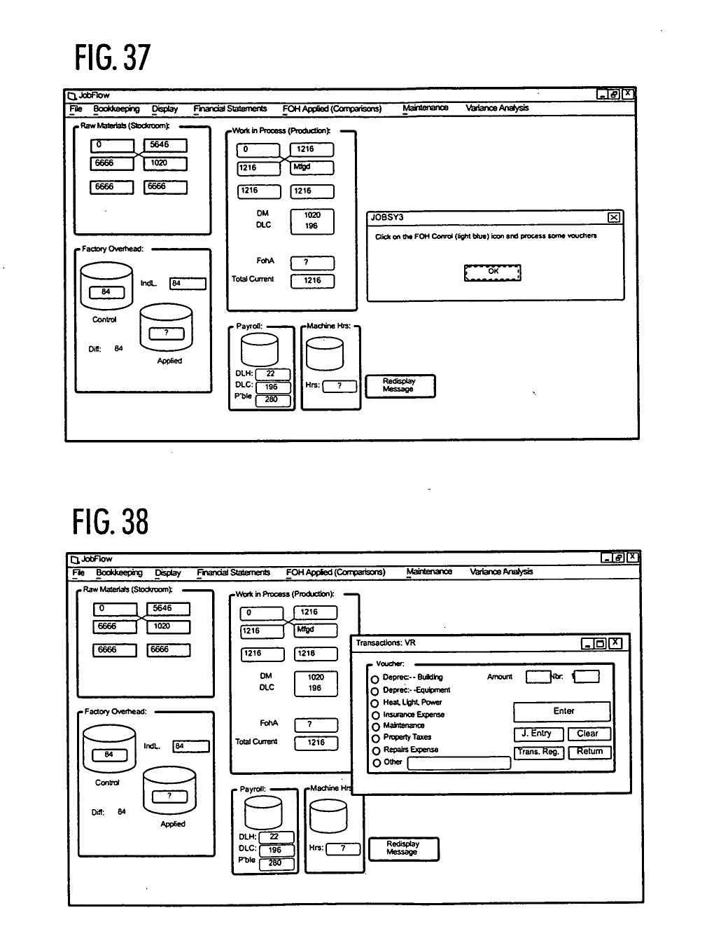

FIG. 33 shows the input to the transfer of finished goods for Job A, which are listed in the transaction report shown in FIG. 34 and shown as journal entries in FIG. 35. Returning to the schematic flowchart in FIG. 36, the value of the work in process is entered in the SE node of that cluster and transferred to the SW node of the “finished goods” cluster. The corresponding ledger entry is shown in FIG. 37.

FIG. 38 showing yet another cartoon, one illustrating shipment of finished goods.

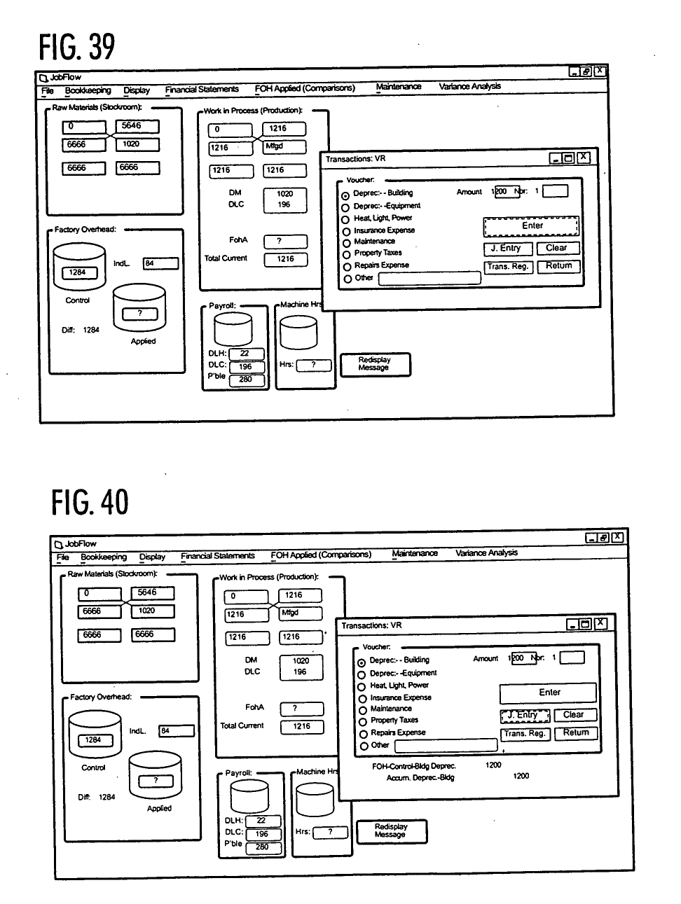

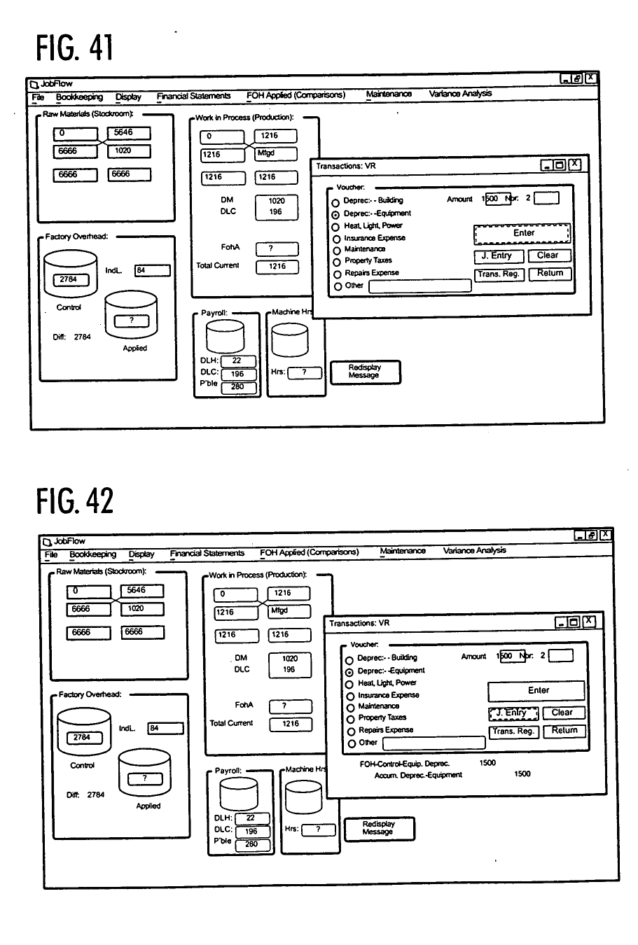

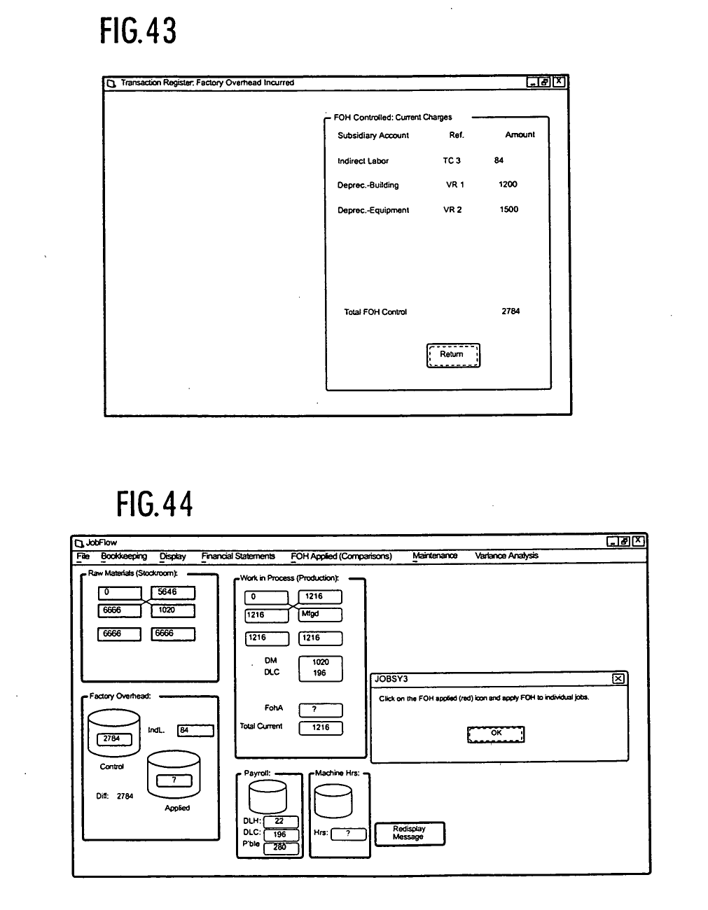

FIG. 39 shows the input for the shipping bill of lading, identifying the job and Job A and the customer as Tiny Toy Co. This input is relected in the transaction report, shown in FIG. 40, and the journal entry, shown in FIG. 41. The schematic, in FIG. 42, now shows the “finished goods” cluster being complete, and the value of the finished goods being entered as the “cost of goods sold” in the profit/loss box. The finished goods ledger also records the entries for Job A.

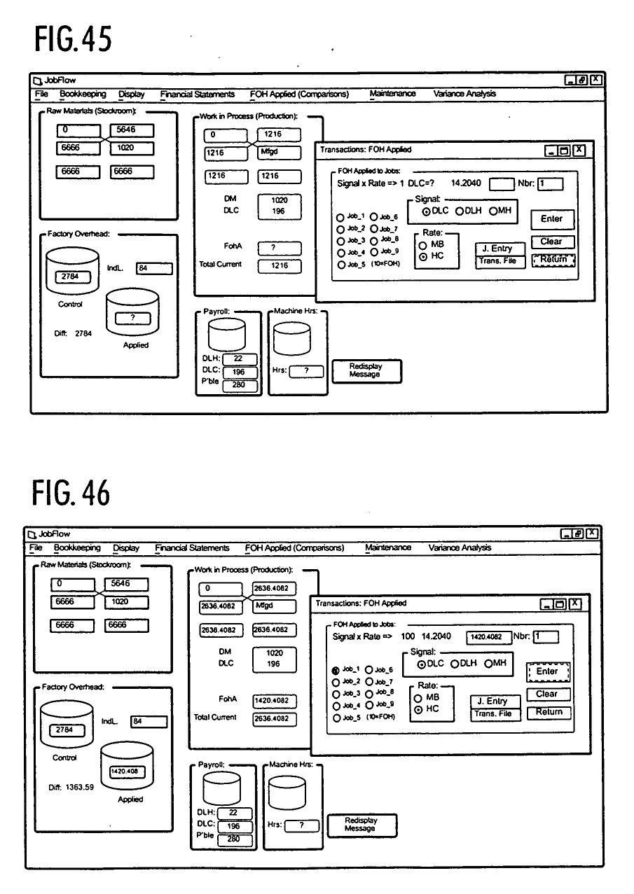

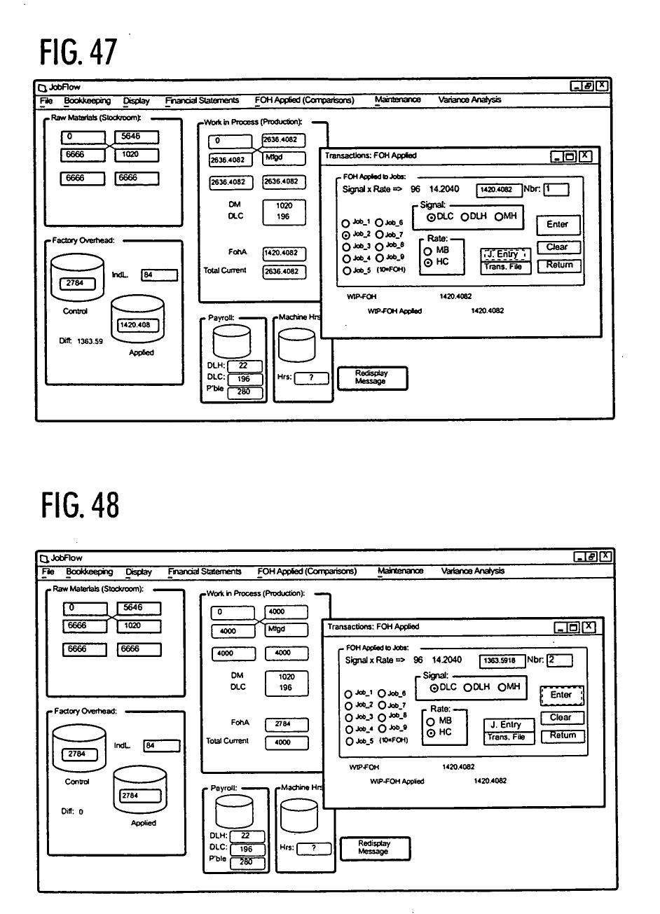

FIGS. 44-47 show the input to a customer billing transaction to create a sales receipt, namely the markup on the cost of goods sold, a list of sales billing transactions in the transaction report, the corresponding journal entries for the billing transaction, and the schematic of FIG. 1 with the impact of the billing transaction, according to a preferred embodiment of the present invention. The sales ledger entries are shown in FIG. 48. The markup assures that the gross margin is positive.

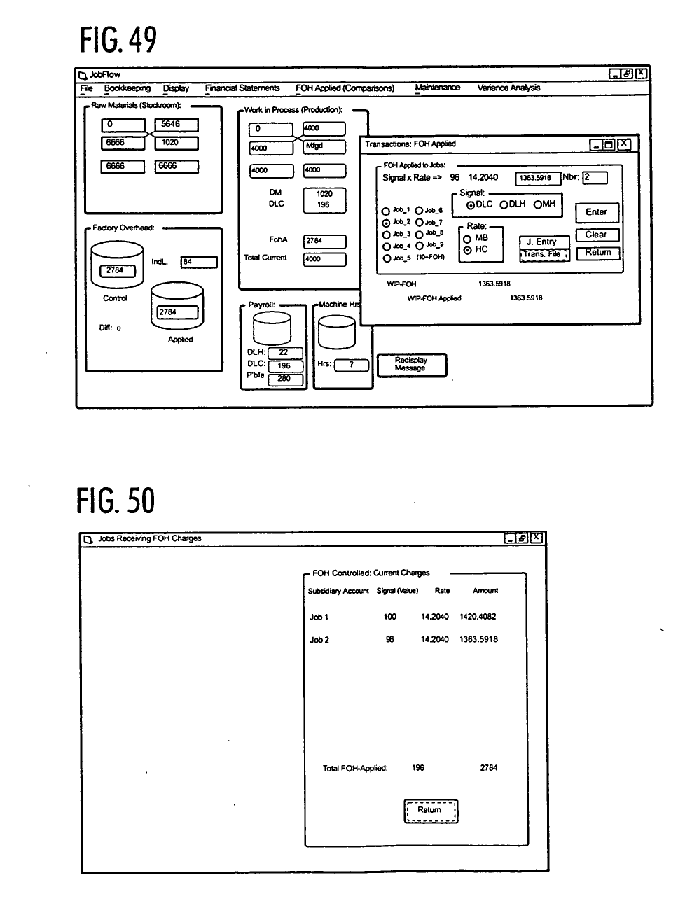

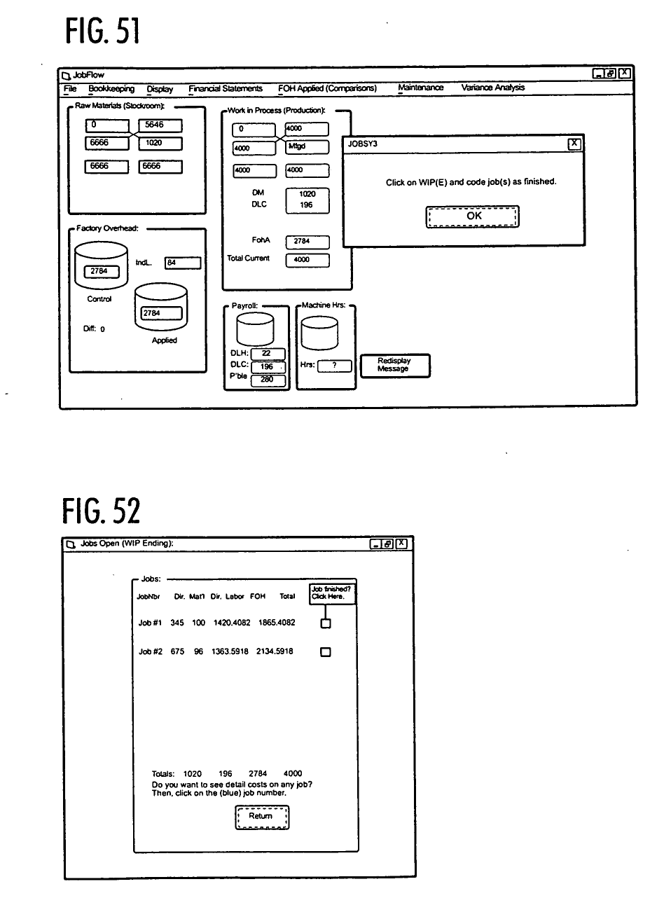

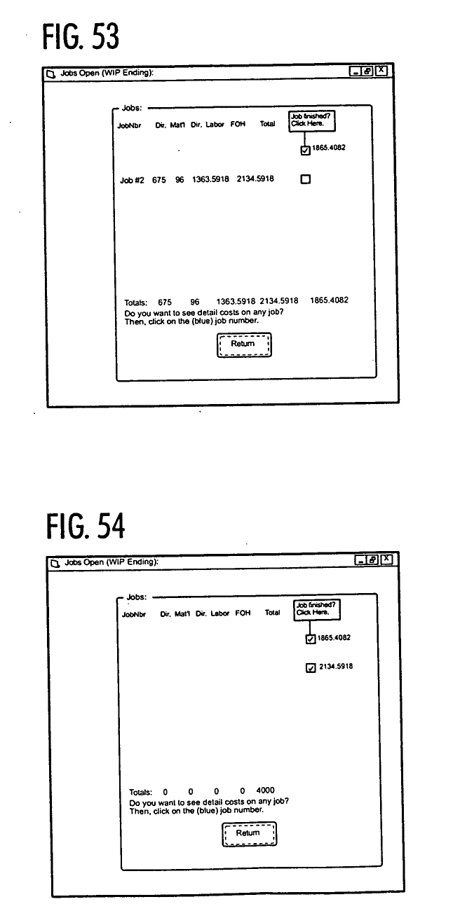

FIGS. 49-52 show the input to the operating expenses, namely transportation costs, and the corresponding transaction report, journal entries, and the schematic flow chart reflecting the transportation costs, which are subtracted from gross margin to yield net operating income. The transportation cost is also added to accounts payable in the SW node. The operating expense ledger records the cost as shown in FIG. 53.

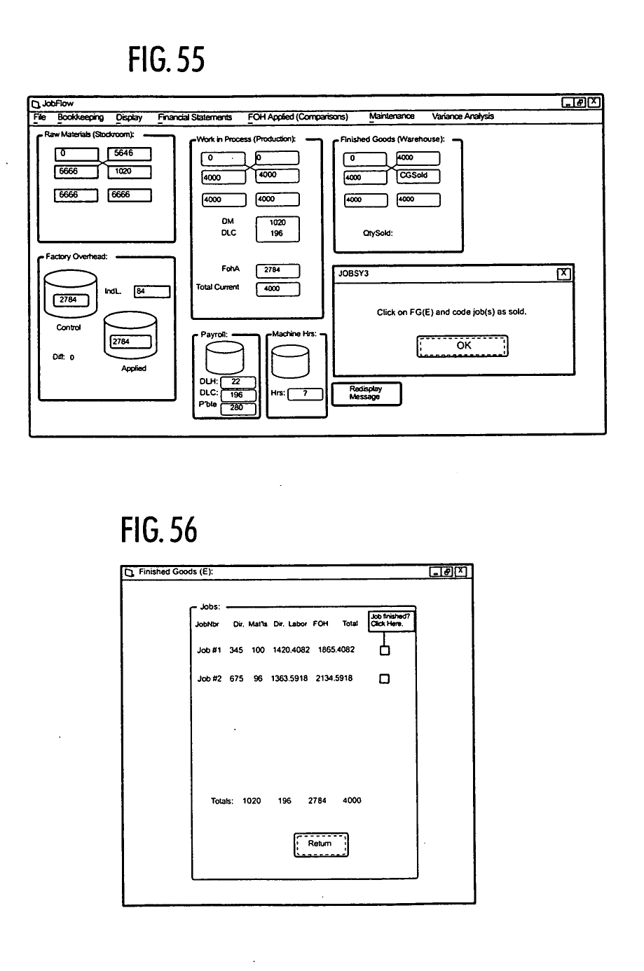

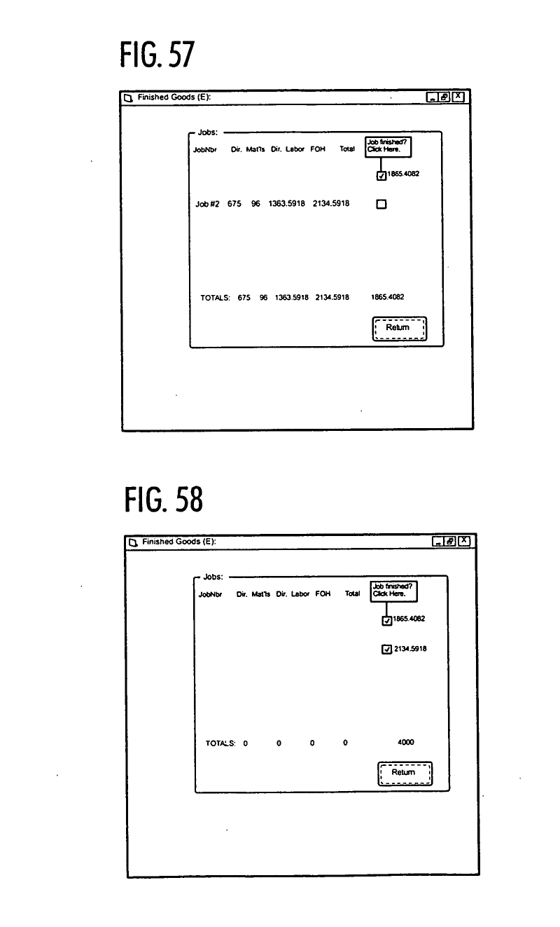

FIGS. 54-57 show input for customer payments for goods sold in Job A, the listing of all remittances for Job A, the journal entry and the schematic flow chart now adjusted to reflect cash received during the accounting interval in the SW node of the “cash” cluster. Note that the amount remitted in this example is also the total cash available for paying the total payments due (which includes payables for vendors, account payable, and wages payable), according to a preferred embodiment of the present invention.

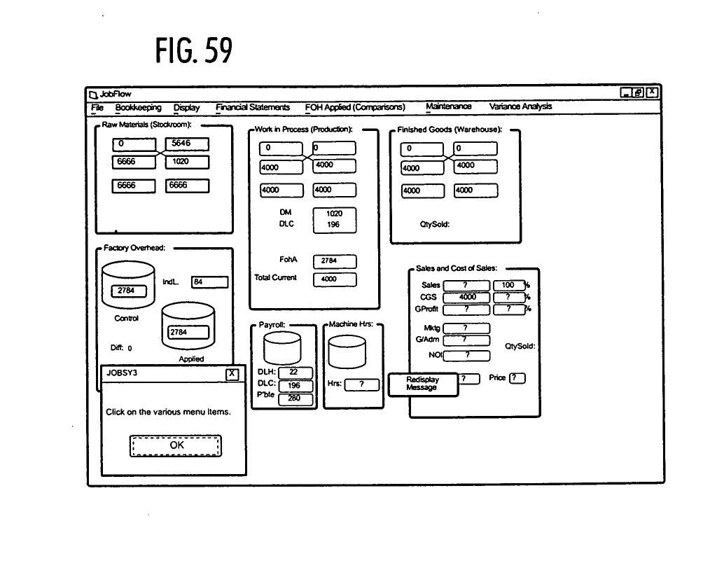

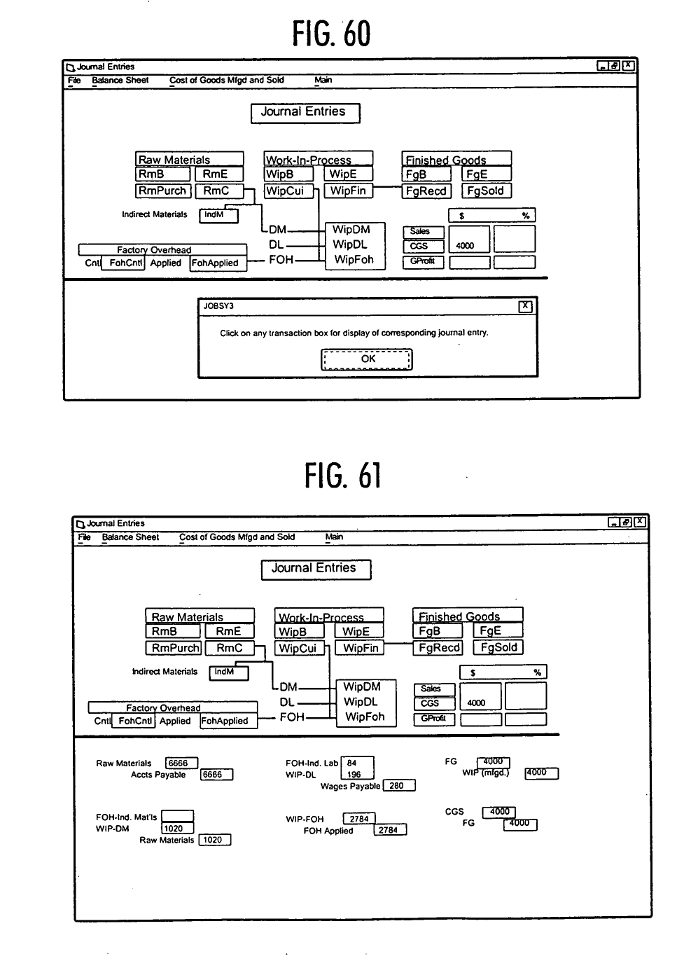

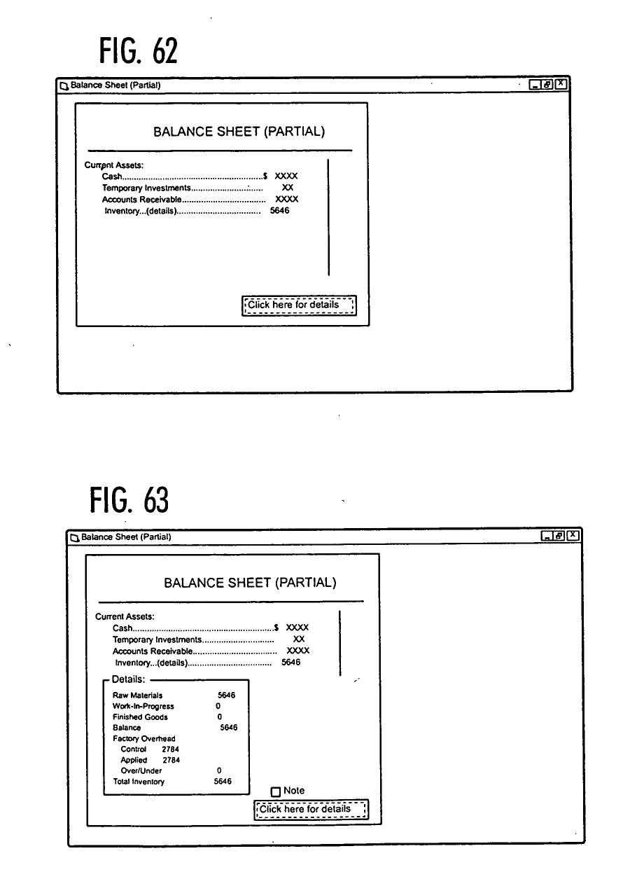

FIGS. 58-61 showing input for payments to vendors, the transaction list of payments to vendors, journal entries for a vendor payments, and the schematic reflecting the impact of payments to vendors. This payment reduces the total cash available and total payments due. The cash ledger reflects these payments to vendors in FIG. 62.

By clicking on the general ledger button (G/L) in the bottom right corner of the schematic flow chart, a trial balance appears (FIG. 63) with the information from the master accounts. It allows an income statement to be prepared from the trial balance information and owner's equity. FIG. 63 is a screen shot showing the trial balance, income statement and owner's equity.

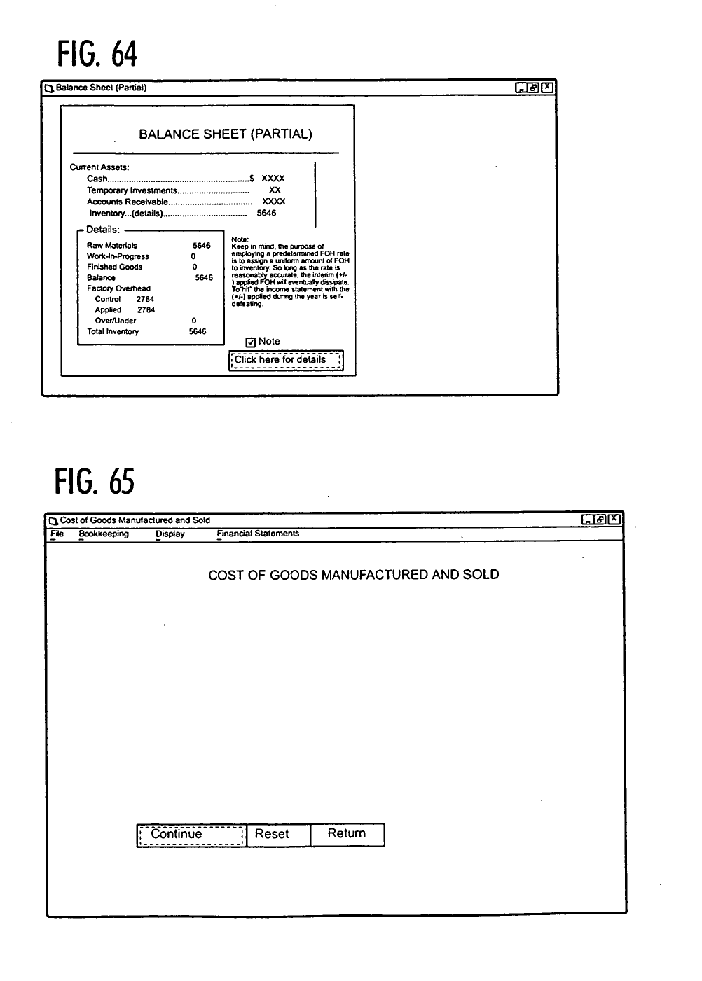

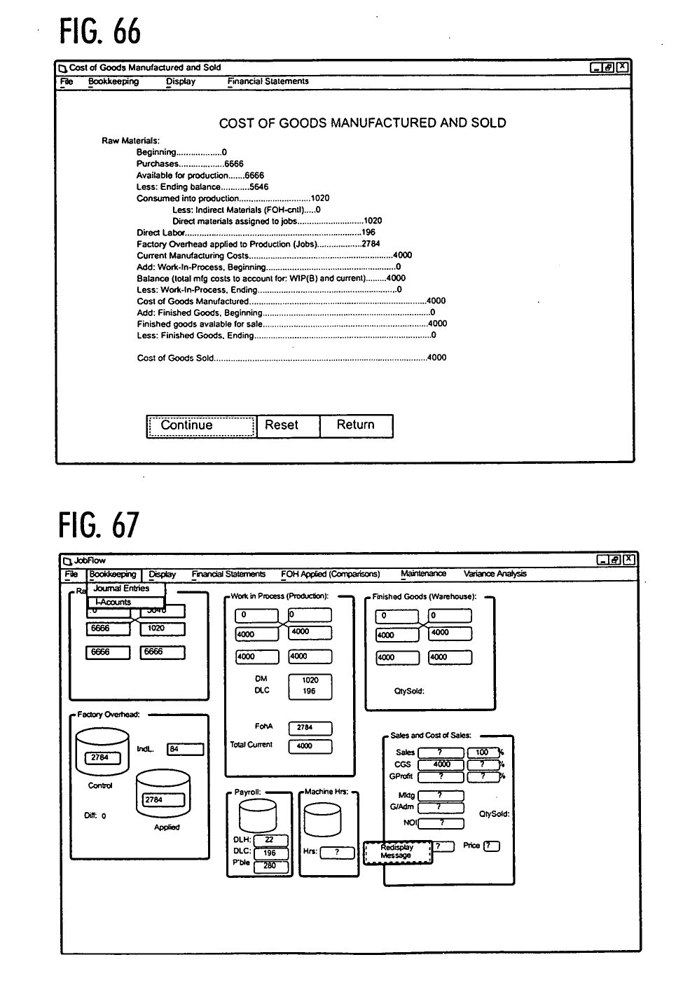

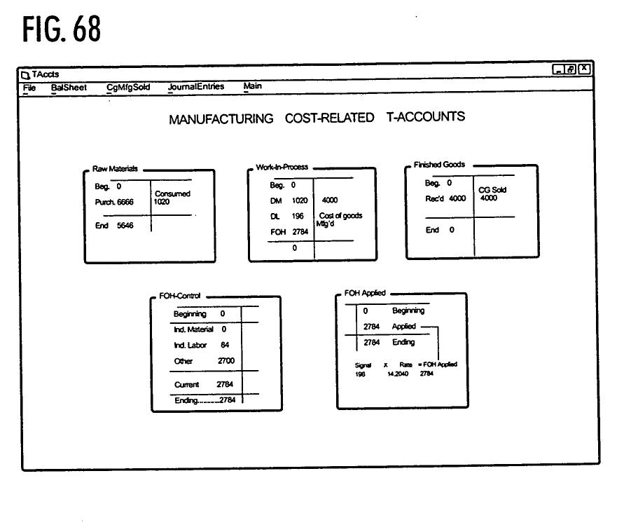

By clicking on the “balance sheet” button in FIG. 63, the income statement is replaced by a balance sheet, as shown in FIG. 64, and the full solution to the cost accounting problem that corresponds to the particular input of the user is then seen. Obviously, a student can experiment with a range of fictitious input or with real world problems to get a sense of the flow of value from one account to another.

It is intended that the scope of the present invention include all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art of lamp manufacture from the foregoing description of the preferred embodiments without departing from the spirit or scope of the present invention.

1. A method for teaching cost accounting, comprising the steps of:
establishing plural accounts, each account of said plural accounts designated for entry of accounting data for a different component of cost accounting; and
displaying said each account of said plural accounts in a configuration having four corners, wherein each corner of said four corners is designated for display of a different value of said four values, a first corner for displaying a first value of said four values, said first value being equal to a beginning balance for said each account, a second corner adjacent to said first corner for displaying of a second value of said four values, said second value being equal to an ending balance at the end of an accounting interval for said each account, a third corner adjacent to said first corner for displaying of a third value of said four values, said third value being transferred into said each account during said interval, and a fourth corner adjacent to said second and said third corners for displaying of a fourth value of said four values, said fourth value being transferred out of said each account during said interval;
providing a fifth value in a location proximate to said first and said second corners, said fifth value equal to the sum of said first and said second values;
providing a sixth value in a location proximate to said third and said fourth corners, said sixth value being equal to the sum of said third and fourth values; and
linking computationally said first, second, third, fourth, fifth and sixth values so that a change made to any one of said first, second, third, fourth, fifth and sixth values causes recalculation of every other of said first, second, third, fourth, fifth and sixth values.

2. The method as recited in claim 1, wherein said establishing step further comprises the steps of:
establishing inventory accounts; and
establishing liability accounts.

3. The method as recited in claim 1, wherein values of said plural accounts are logically interrelated so that a value in a first account of said plural accounts affects a value in a second account of said plural accounts, and wherein said method further comprises the step of linking computationally said value from said first account with said value of said second account.

4. The method as recited in claim 1, further comprising the step of displaying said plural accounts in a single window of a software application.

5. The method as recited in claim 1, further comprising the step of establishing a transaction report for said each account of said plural accounts, said transaction report listing transactions during said accounting interval and providing a total transaction value linked computationally to one of said second and said third values of said account.

6. The method as recited in claim 1, further comprising the step of establishing a ledger for said each account, said ledger containing transaction data and balance data for each transaction during said accounting interval.

7. A software application for teaching cost accounting, said software application adapted for use on a general purpose computer, said software application comprising:
a schematic flow chart including plural accounts arranged on a window of a software application, each account of said plural accounts being linked to at least one other account of said plural accounts;
master accounting files for said plural accounts linked to said plural accounts;
means for inputting data into said software application so that a user can create cost accounting problems; and
computational means for distributing said data to and combining said data in said master accounting files and said plural accounts in accordance with cost accounting rules so that said master accounting files and said plural accounts display said data,
wherein said each account of said plural accounts is displayed in a configuration having four corners, wherein each corner of said four corners is designated for display of a different value of said four values, a first corner for displaying a first value of said four values, said first value being equal to a beginning balance for said each account, a second corner adjacent to said first corner for displaying of a second value of said four values, said second value being equal to an ending balance at the end of an accounting interval for said each account, a third corner adjacent to said first corner for displaying of a third value of said four values, said third value being transferred into said each account during said interval, and a fourth corner adjacent to said second and said third corners for displaying of a fourth value of said four values, said fourth value being transferred out of said each account during said interval.

8. The software application as recited in claim 7, further comprising the steps of:
providing a fifth value in a location proximate to said first and said second corners, said fifth value equal to the sum of said first and said second values;
providing a sixth value in a location proximate to said third and said fourth corners, said sixth value being equal to the sum of said third and fourth values; and
linking computationally said first, second, third, fourth, fifth and sixth values so that a change made to any one of said first, second, third, fourth, fifth and sixth values causes recalculation of every other of said first, second, third, fourth, fifth and sixth values.

9. The software application as recited in claim 7, further comprising the step of providing an image with said each account of said plural accounts, said image depicting an activity associated with said each account.

10. The software application as recited in claim 7, wherein said plural accounts include accounts for raw material, work-in-process, finished goods, manufacturing overhead expense, manufacturing overhead applied, wages payable and vendors payable.

11. The software application as recited in claim 10, wherein said software application includes accounts for accounts payable and cash.

12. The software application as recited in claim 7, wherein said inputting step further comprises includes inputting values for raw materials received, raw materials requisitioned, time expended per job by employee, manufacturing overhead costs, manufacturing overhead costs applied by Job, finished goods transferred, and goods shipped to customers.

13. A cost accounting tutorial machine, comprising:
plural ledgers;
means for entering cost accounting data into said ledgers;
computational means in operational connection with said entering means and said plural ledgers for analyzing, combining, and distributing said cost accounting data; and
displaying means adapted to display plural accounts, each account of said plural accounts corresponding to a ledger of said plural ledgers, said each account being displayed in a configuration having four corners, wherein each corner of said four corners is designated for display of a different value of said four values, a first corner for displaying a first value of said four values, said first value being equal to a beginning balance for said each account, a second corner adjacent to said first corner for displaying of a second value of said four values, said second value being equal to an ending balance at the end of an accounting interval for said each account, a third corner adjacent to said first corner for displaying of a third value of said four values, said third value being transferred into said each account during said interval, and a fourth corner adjacent to said second and said third corners for displaying of a fourth value of said four values, said fourth value being transferred out of said each account during said interval.

14. The machine as recited in claim 13, wherein said displaying means displays a fifth value in a location proximate to said first and said second corners, said fifth value equal to the sum of said first and said second values, and a sixth value in a location proximate to said third and said fourth corners, said sixth value being equal to the sum of said third and fourth values, and wherein said computational means links said first, second, third, fourth, fifth and sixth values so that a change made to any one of said first, second, third, fourth, fifth and sixth values causes recalculation of every other of said first, second, third, fourth, fifth and sixth values.

15. The machine as recited in claim 13, wherein said computation means is adapted to generate transaction reports from said cost accounting data.

16. The machine as recited in claim 13, wherein said displaying means displays an image with said each account of said plural accounts, said image depicting an activity associated with said each account.
